(19) United States
(12) Patent Application Publication
(10) Pub. No.: US 2004/0191533 A1
(43) Pub. Date: Sep. 30, 2004

(54) Coated glasses and method for their manufacture

(76) Inventor: Karl-Heinz Wendt, Seevetal (DE)

Correspondence Address: Alan B. Clement, Esq., Hedman & Costigan, P.C., 1185 Avenue of the Americas, New York, NY, 10036, US

(21) Appl. No.: 10/724,574

(22) Filed: Nov. 28, 2003

(30) Foreign Application Priority Data
Nov. 27, 2002 (DE) 102 55 507.9

(51) Int. Cl. B05D 1/36; B32B 17/06

(52) U.S. Cl. 428/435; 427/402; 427/372.2; 428/426

(57) ABSTRACT

The invention relates to coated glass as well as a method for its manufacture.

The invention relates to coated glasses and a method for their manufacture.

The process of coating glass by staining has been known for a long time. As far back as the 10th century, glass panes of churches were provided with color coatings for depicting Christian motifs. The antique glass paints were most often mineral in origin, applied to the panes with a brush and subsequently burned in. The burning in process involves a heat treatment that melts open the glass surfaces to permanently bond the colored mineral pigments applied beforehand to the glass surface. The color is burned in at 550° to 700° C., for example.

Glasses are still commonly coated even today for purposes of decoration or inscription. Glass surfaces sectionally provided with a protective layer or safety labels are also known.

Numerous coating systems, such as conventional colors or adhesive films, can only be used inside, however, and even there only have a limited life. Coating even special glasses like fireproof or safety glasses with conventional paints or films is impossible or impermissible, because, in the case of burn in colors, the coating and/or temperature treatment alters the constitution of the glass panes, creating the danger that they will no longer comply with the parameters required for approval, so that each retreated glass pane must again be approved.

Single-sheet safety glasses (ESG) have previously been coated with burn in colors exclusively on one side. The glass is here imprinted with the color in a silk screen-printing process, and then heated in a furnace to approx. 700° C., wherein the ceramic color particles are melted together with the glass surface. However, coating with a burned in ceramic color causes the ESG to lose up to 40% of its surface tension, and losses in surface tension must be avoided.

In addition, the disadvantage to many ceramic colors is that they easily oxidize outside, have inadequate UV resistance, and experience diminished color brilliance caused by exposure to the elements. Another disadvantage to ceramic burned in colors is that approx. 15 to 20% of the glasses coated in this manner break during manufacture, e.g., during he so-called “heat-soak test”. Further, coating must take place before the glasses are installed, and can no longer be changed or removed at a later point.

Other glass-decorating processes, such as etching and sandblasting, also permanently change/damage the glass surface and the physics relating to the glass.

The object of this invention is to provide coated glasses and a method for their manufacture that does not have the disadvantages described above. Coating would not require the bum in step, could take place at room temperature, would be permanent and weather-resistant, and would be completely removable. In addition, the coating method would result in only negligible, if any, changes in the mechanical, chemical and physical properties of the glass.

The object is achieved according to the invention with coated glasses and a method for their manufacture based on the independent claims. Preferred embodiments are contained in the subclaims, or described below.

All procedural steps required for applying the coating, e.g., cleaning, polishing, priming, coating and drying, preferably take place at room temperature, but in any event at temperatures of below 100° C., preferably below 50° C.

Fabrication of the special glass coated according to the invention preferably involves the following steps:

a) Cleaning the glass surface with a fat-removing glass cleaner, e.g., an alcoholic and/or surfactant glass cleaner (step a) can also be part of step c));

b) Grinding or polishing the glass surface with steel wool, in particular without detracting from the translucence of the glass body;

c) Coating the glass surface with a primer/cleaner (optional), abrading, also to remove excess primer/cleaner, e.g., using a lint-free cotton rag, and drying (at least one, preferably at least two, of steps a), b) and c) are carried out);

d) If necessary, applying a partial covering (after drying), e.g., masking film, to the glass surface;

e) Applying the mineral particle-containing polyacrylate lacquer, preferably in several layers, e.g., 4 to 8 layers;

f) Allowing the polyacrylate lacquer to dry;

g) Completely or sectionally remove the partial covering (if step d) was performed), and

h) If necessary, abrading the coating, e.g., with a rough sponge (such as a Scotch® sponge), a synthetic nonwoven (such as Mercury Ultra 17 from Spontex®) or a lint-free cotton rag, to break the edges of the lacquer coating, in particular toward the masking film.

Steps d to g or d to h are repeated if differently colored polyacrylate lacquers are applied one after the other, or if the goal is to generate zones of the same polyacrylate lacquer that vary in thickness. To this end, the partial covering in step d) is usually removed for respectively defined surface areas.

Polyacrylate lacquers in terms of the invention are acrylate binding agents cured with isocyanates. Strictly speaking, then, the cured polyacrylates involve polyurethanes. However, since they are based on resins of acrylic monomers, i.e., acrylic resins/acrylate resins, they are here referred to as polyacrylate lacquers. Lacquer is a composition respectively consisting of at least binder and hardener or its cured coating, resin, the uncured binder.

Polyacrylate binders, also called acrylic resins, polyacrylates, acrylate resins or polyacrylate resins, are manufactured via polymerization, mostly via radical solution polymerization, of the acrylic monomers, i.e., (meth)acrylic acid and its derivatives (in particular esters). In particular, hydroxy and/or carboxy-functionalized derivatives of (meth)acrylic acid are used to manufacture the polymer.

The isocyanate hardener involves polyfunctional isocyanates, which have at least two isocyanate groups, such as MDI, TDI (toluylene diisocyanate), HDI (hexamethylene diisocyanate) and/or HDI biuret (aliphatic polyisocyanate). However, isocyanate-modified prepolymers are also suitable. The latter are preferably incorporated in an organic solvent.

In a special embodiment of the invention, the polyacrylate lacquer additionally contains dyes for the manufacture of colored coatings.

The coating according to the invention is a cold coating that can be applied at 5° C. to 35° C., in particular at room temperature, and need not be burned in or cured under an elevated temperature. Curing takes place chemically.

The coated glasses give the visual impression of etched glasses, since the applied coating shimmers in the light, and slightly refracts the light. By contrast, sandblasted panes create a matte impression. The glasses coated according to the invention are largely resistant to showing any signs of having been used; in particular, no fingernail scratches or fingerprints are left behind during use, as opposed to sandblasted or etched glasses. The glass surfaces coated according to the invention are additionally easy to clean and disinfect.

The cured coating preferably has a layer thickness of 10 to 50 μm, in particular 15 to 30 μm.

It is important to use the primer to achieve a permanent, moisture-resistant coating.

The primer/cleaner preferably includes or comprises a polar, organic solvent, e.g., one or more hydrocarbon compounds with 2 to 12 carbon atoms, preferably 2 to 4, with at least one of the following groups: alcohol, keto, aldehyde, ester or acid group(s). Preferably C2 to C3 alcohols, in particular a mixture of ethanol and butanone (CAS 78-93-3). The primer/cleaner is preferably essentially free of water (<5%w/w, preferably <1%w/w). The primer and/or cleaner (primer/cleaner) is preferably applied in an amount of up to 20 to 80 g/m², in particular of up to 40 to 60 g/m².

The primer or primer/cleaner according to step c) differs from the cleaner according to step a) at least in that the cleaner according to step a) preferably contains substantial quantities of water.

The glass surface can initially be precleaned with a commercially available cleaner to remove simple contaminants, such as dust or splashes of water, preferably with an aqueous cleaner, preferably containing more than 50% w/w of water. The glass surfaces are then polished to remove any chemical contaminants, such as SO² vapor deposits or silicate coatings, which form in particular during the manufacture of the special glasses. Polishing can take place using a grinder and stainless steel wool; however, the glass surface is not damaged in the process, as only contaminants sticking hard to the glass surface are removed.

The silicate coating can arise when cutting the glasses to size using a water jet, for example. Fireproof glazed glasses consist of several panes having layers of chemically bound water glass. While cutting with a water jet, silicate is rinsed onto the glass surface in the form of silicate anions. Other contaminants that can arise during the manufacture of glass include the vapor deposition of sulfur dioxide. Surprisingly, contaminants like these have proven to be disruptive, since they impair the permanent adhesion of the coating, in particular during exposure to moisture.

The glass surface can be cleaned again after the primer/cleaner treatment, for example, with a soft rag, to remove residual cleaner, distribute the cleaner and/or primer and for drying purposes.

The actual coating is a 2-component lacquer comprised of at least one polyacrylate binder containing mineral particles and at least one polyisocyanate hardener. If possible, the share of solvent in the 2-component lacquer prior to application measures 20 to 80 % w/w, preferably 30 to 70% w/w. The polyacrylate lacquer containing the hardener and mineral particles is preferably applied via silk-screen printing, spraying (e.g., airbrush) or rolling, with silk-screen printing or spraying being especially preferred.

The polyacrylate lacquer can be sprayed, rolled, brushed or applied to the glass pane via airbrush or silk-screen printing. The coating is preferably sprayed on with a low-pressure spray gun or in a silk-screen printing process. Spray gun coating takes place in particular for already installed glass panes.

To remove excess color and solvent, a lacquer mist exhauster can be used during the spraying process. The latter makes sense in particular when coating built-in special glasses in already used rooms. The method according to the invention thereby makes it possible to coat installed glass panes on site.

After a drying period of approx. half an hour or less, the masking tape or masking film is removed. The coating surface is already dried and moisture-resistant after 20 minutes. After approx. 6 to 8 hours, all solvents have escaped the polyacrylate lacquer. After approx. 48 hours, the coating surface can be cleaned with a commercially available glass cleaner. The coating can be exposed to a physical load after three days. Curing is achieved after approx. 10 days.

The coating preferably contains no white pigments and no softeners, which would ignite in case of fire and create a new source of fire.

Commercially available organic pigments are here preferably used as the color pigments, if possible in the form of color pastes. Fluorescent identifiers can suitably be added as well, if necessary in addition to the color pigments. In particular when coating fireproof glazed glasses, it has proven beneficial to use phosphorescent, glow-in-the-dark dyes, e.g., along escape routes given a lighting failure caused by fire.

The mineral particles preferably have an average particle size of 5 to 25 μm, and are preferably inorganic oxides of aluminum, silicon or mixed oxides thereof, in particular aluminum oxide or metal oxide, such as titanium dioxide, zinc oxide and/or iron oxide, sheathed glimmer particles. Iroidine® products from Merck are suitable, for example. The latter are preferably added to the lacquer in the form of a slurry/dispersion in an organic medium.

Residual deposits on the glass are removed via polishing or grinding, preferably via polishing with steel wool, in particular stainless steel wool.

Masking film delineating the desired pattern is applied dry so as not to disturb any primary film that might be present. The edges of the glass pane are taped off, as are surfaces not to be coated. The masking film can be any commercially available film that can be completely removed from the pane again without a trace. The desired pattern is transferred to the film beforehand. The masking film remaining on the pane represents a negative of the later coating. If only a uniform coating of the entire element is desired, masking film need not be used. The film can also be removed only over the course of several operations, i.e., only specific, respectively stamped out or precut sections, to fabricate areas of varying coatings on the glass surface.

The special glasses coated according to the invention can also be removed from the coating again without at race. To this end, the pane is treated with a special coating remover, e.g., a dichloromethane-containing paint stripper. Since the glass surface was not damaged during the coating process, there are also no grooves or notches, e.g., of the kind produced during sandblasting.

The glasses used according to the invention are described below. Glass is manufactured by melting together basic and acidic oxides. Window glass is fabricated out of quartz sand (SiO₂), soda (Na2CO₃) and lime (CaCO₃). CO₂ is cleaved while heating, and the formed basic oxides CaO and Na₂O react with the acidic oxide SiO₂ to form a sodium-calcium silicate. Varying the used oxides yields glasses with different properties. Typically, such a glass consists of the following:

| | | |
|---|---|---|
| Silicon dioxide | SiO₂ | 69%-74% |
| Sodium oxide | Na₂O | 12%-16% |
| Calcium oxide | CaO | 5%-12% |
| Magnesium oxide | MgO | 0%-6% |
| Aluminum oxide | Al₂O₃ | 0%-3% |

Borosilicate glass contains an additive of approx. 7% to 15% boron oxide. The following additives are used for color glasses in small quantities:

| | | |
|---|---|---|
| Iron monoxide | FeO | Light green |
| Chromium trioxide | Cr₂O₃ | Dark green |
| Cobalt monoxide | CoO | Blue |
| Neodyme trioxide | Nd₂O₃ | Violet |

In order to manufacture float glass, the glass melt flows via a liquid metal bath (e.g., a zinc bath), the float bath. This method can be used to inexpensively obtain high-quality plane-parallel glass. The brittle surface structure gives float glass a low bending tensile strength, and when it breaks, it splinters into large, sharp-edged shards. The softening point lies at approx. 600° C. The technical guidelines or standards also refer to this glass as mirror glass (SPG). However, plastic glass like acrylic glass is also suitable.

Whether due to safety considerations or because a reduced glass thickness at the same strength level helps to save on energy, more and more products require cured glass for impact or splinter protection. Taking panes cut to their final geometry and, if necessary, drilled and heating them to 600° C. to 700° C. and quenching the surface yields single-sheet safety glass (ESG) that cannot be further processed. The surfaces of the glass cured immediately when blown off with cold air, while the core of the pane remains hot. During subsequent cooling, the core tends to contract, but this is prevented by the already cured surfaces. The resultant secondary bending prestresses the core against tensile forces, and the surfaces against pressure. The maximum compressive stresses on the glass surface range between 90 N/mm² and 120 N/mm². The flexural strength can here measure up to 200 N/mm². ESG breaks up into numerous small fragments when this bending tensile stress is exceeded.

So-called chemical prestressing or chemical solidification is used as an alternative to thermal prestressing in thinner panes (pane thickness 2 to 3 mm). The pane can also be prestressed by immersion in hot potassium nitrate. An ion exchange takes place on the surface of the glass. The sodium ions of the glass are replaced by the larger potassium ions in the melt. This generates pressure on the surface of the glass. The glass edges are also prestressed here. The strength increases. However, the prestressing is limited to only a relatively thin edge area, and is only used at pane thicknesses of 2-3 mm.

Single-sheet safety glasses (ESG) are normally used in glass facade construction and inside for glass wall separating systems and glass door assemblies. In order to balance out the loss in surface tension encountered in coatings applied according to the burn-in method, glass thicker than for uncoated glasses is mandatory. This also gives rise to higher costs for frame construction, and creates structural limitations with regard to use. The coated single-sheet safety glasses according to the invention impair the surface tension of prestressed glasses to only a very negligible extent, or not at all, and can therefore also be incorporated in smaller layer thicknesses. The coated special glasses according to the invention can also be coated on both sides of the glass pane, while conventional burn-in coatings in ESG may only be applied to one side, or require an expensive stress relief of the glass.

Bonding several glass panes (float, partially or completely prestressed glasses) results in composite safety glass (VSG). 0.38 mm to 2.28 mm thick PVB film (polyvinyl butyral), PVA film (polyvinyl acetate) or casting resins are sued as the bonding layers. The advantages are splintering in the case of pane failure and the residual load-bearing capacity ensured by the film.

While normally used window glass (float glass) is a non-combustible building material, it would shatter given exposure to high temperatures as the result of a fire. Fireproof glazed glasses are components with one or more translucent elements comprised of a frame, specific fireproof glasses, mounts, gaskets and attachment material, and remain fire resistant for 30, 60, 90 or 120 minutes depending on classification. They are divided into two fireproof classes according to DIN 4102, Part 13:

| Fireproof Class | | Fireproof Duration |
|---|---|---|
| F glazing | G glazing | in minutes |
| F 30 | G 30 | ≧30 |
| F 60 | G 60 | ≧60 |
| F 90 | G 90 | ≧90 |
| F 120 | G 120 | ≧120 |

These kinds of special glasses are used above all in glass facings in fireproof doors, fire gates, interior glazed panes of escape vehicles.

F glazings are fireproof glazings whose fireproof duration prevents the propagation of fire and smoke, as well as the passage of high-temperature thermal radiation. F glazings become opaque during exposure to fire, and form a heat shield. They behave like walls in terms of fire protection. During tests at fire temperatures according to the standard temperature-time curve, the temperatures on the side of the test specimen facing away from the fire must on average not increase by more than 140 K, and to more than 180 K over the initial temperature of the test specimen at the beginning of the test at any measuring site (see DIN 4102, Part 13, Table 3). F glazings are barriers to thermal radiation. F glazings are basically glazings comprised of multiple layers. The fireproofing effect is based on chemical compounds introduced between the panes (e.g., water glass) that evaporate during exposure to heat. The individual panes consist of composite safety glass or single-sheet safety glass. Evaporation fills the gap between the panes, and prevents heat from the source of the fire from radiating through the window for a specific period of time.

Type F fireproof glass, for example, can consist of several layers of glass, e.g., float glass, filled inside with layers of alkali silicate, which foams up in the case of fire. The alkali silicate layers are approx. 1.5 mm thick, and sealed around the edges. The alkali silicate contains water. It is also possible for the fireproof glass to also have one or more composite safety glass panes consisting of two glass panes joined by means of a polyvinyl acetate (PVA) or polyvinyl butyral (PVB) film.

Fireproof glazings in fireproof class G are also fireproof glazings whose fireproof duration prevents the propagation of fire and smoke. In case of fire, they remain translucent and behave like glass in terms of fire protection. G glazings must then also remain active and seal the room. No flames can spring up on the side facing away from the fire. Thermal radiation is only impeded, not prevented as in the case of F glazings.

G glazings are special components for fire protection. They can only be installed at sites where there are no concerns relative to fire protection, e.g., lights in corridor walls serving as escape routes. However, the lower edge of the glass must as a rule be situated at least 1.80 m over the floor, so that one wall offers a shield against radiation in case of fire.

The unimpeded passage of heat rays through the clear glass can cause ignition of materials and components lying opposite the glazing and source of fire. G glasses most often are single-sheet glazings that do not prevent passage of thermal radiation as opposed to F glazing, and must not melt or burst during the stipulated fireproof duration. They often consist of glass manufactured at very high temperatures (approx. 1200° C.) out of boron-alumina mixture, which is responsible above all for the high thermal resistance of these glasses. Such borosilicate glasses are also referred to as JENAER GLASS.

The level of fireproofing can be increased further via the vapor deposition of metals and the resultant reflection of heat rays. A fireproof quality of up to G120 is possible. Wire netting cast into the glass pane prevents the pane from shattering.

Glasses particularly suited for the coating used according to the invention are prestressed single-sheet safety glass (ESG), including multi-layer composite glass containing ESG along with fireproof glass with type G glazing, in particular borosilicate glass. It was surprisingly shown that the coating used according to the invention only negligibly reduces the prestressing of ESG, if at all.

Typical examples are fireproof glasses such as Pyrodur® and Pyrostop® from Pilkington, Pyroswiss® and Contraflam® from Saint Gobain and Pyrane from Schott.

Fireproof glasses must be individually approved per respective element. Processing or altering the individual elements annuls the approval, since this may adversely influence behavior in case of fire. For example, films affixed to the pane might be flammable, and hence detract from the service life of the pane.

Fireproof glasses cannot be coated with burn-in colors in a silk-screen printing procedure, because the panes cannot be heated, making it impossible to burn in the color. The only method available to date for coating fireproof glasses without altering the surface tension and losing approval of the fireproof elements involves additionally placing a pane with ceramically burned-in silk-screen printing colors in front of the fireproof glass. Only special types of fireproof elements themselves tested for approval are suitable for this purpose. Such a pane structure is thick, and requires a more complex and stronger frame construction. Fireproof glasses can also not be etched or sandblasted. Therefore, these glasses, in particular G glazings, cannot be subsequently coated.

Surprisingly, the fireproof glazings coated according to the invention experience no deterioration in their fireproofing behavior. Applying the coating at room temperature triggers no change in the glass elements owing to thermal exposure. Since no mechanical stress is placed on the glass surface during the coating process, the surface tension of the glass elements is also retained. The fireproof glazings do not change their behavior in case of fire due to the coating according to the invention, so that the respective fireproof class is retained. The coating as such is not flammable, and turns bright again when melted with the glass surface during prolonged exposure to higher temperatures.

In particular when using the coatings according to the invention in areas where the glass panes must be disinfected/sterilized, e.g., hospitals, it is advantageous to provide the coatings according to the invention with another layer consisting of a parent lacquer (without mineral particles) and hardener, e.g., in a ratio of 80 to 50 to 50% w/w of additional lacquer layer. Such a coating effectively prevents the viruses, bacteria, etc. from penetrating into the coating, and makes it possible to effectively disinfect/sterilize the glass surface, even with aggressive media.

The coatings according to the invention are also suitable as sun protection, in particular on composite safety glass (VSG). The coatings are light-fast, scatter sunlight and absorb in the UV range.

The coatings according to the invention can also be used on translucent bodies as a part of floodlight systems. This is because, when light is introduced into the translucent body, it reflects on the coated partial surfaces, allowing them to translucently radiate. Color progressions and gradations in the coating, and hence in lighting effect, are possible. The translucent bodies can consist of mineral glass or acrylate glass. The light is preferably introduced into the translucent body at uncoated surfaces, in particular at the cut edge of the glass body. The translucent body can be a glass pane, e.g., used as an illuminated display or illuminated billboard.

### EXAMPLES

### Example 1

### Manufacture of a Coated Single-sheet Safety Glass

100 ml of polyacrylate binder containing mineral particles (solvent share approx. 56 % w/w) (GLAS-MA5 transparent, also containing 15-25% w/w naphtha, 10-15% w/w n-butyl acetate, 5-10% w/w 2-methoxy-1-methylethyl acetate, 5-10% w/w 2butoxyethyl acetate) were reacted with 20 ml of isocyanate hardener GLAS-MA® hardener 405-19 (including 20-25% w/w n-butyl acetate, 10-15% w/w 3-glycidoxypropyl trimethyoxysilane, <0.5% w/w hexamethylene-1.6-diisocyanate; >0.5% w/w methanol) and 60 ml of diluent (mixture of 80-85% w/w n-butyl acetate, 5-10% w/w xylene, 5-10% w/w 2-methoxy-1-methyl acetate and 1-5% w/w ethyl benzene). The mixture was introduced into a low-pressure injector. If necessary, it can be filtered through a sieve beforehand.

A single-sheet safety glass pane (18 cm×23 cm) was initially cleaned with a conventional glass cleaner and then polished with an eccentric grinder using stainless steel wool. The cleaning agent-primer mixture (including GLAS-MA® special cleaner, containing 95-99% w/w ethanol, 1-5% w/w butanone) was then uniformly applied with a spray bottle, and excess cleaner was removed with a soft rag.

The pre-stamped masking film was affixed to the pane, and the recesses removed from the pane. The edge was then taped off with commercially available adhesive tape.

The pane was placed upright and coated using a low-pressure spray gun. 6 layers were applied to achieve a layer thickness of about 25 μm. Excess spray mist was exhausted using a suction device with suction surfaces positioned roughly perpendicular at the glass plate end. After approx. 10 min., the masking film was removed. After curing, the corners that formed at the edge of the coating toward the masking film were broken by rubbing the coating with a dry fleece (Mercury Ultra 17, Spontex). Tests followed to check the chemical and mechanical properties. Respective coating takes place analogously (layer thickness approx. 40 μm).

### Example 2

### Removal of Coating

The coatings according to the invention can be removed using a dichloromethane solvent (50-100% w/w dichloromethane, 20 to 25% w/w ethanol, 0.1 to 2.5% w/w butanol, 0.1 to 2.5% w/w 1-methoxy-2-propanol), e.g., using a saturated rag.

In general, the paint stripper, i.e., in particular the halogenized solvent, is advantageously applied, and the glass surface is then covered with a solvent-resistant film to lower evaporation and increase exposure time. Commercially available Frapan® film can be used as the film, for example.

### Example 3

### Color Paste

A color coating can be fabricated by adding to the polyacrylate binder in Example 1 a color paste which, in addition to organic color pigments, contains a polyester resin binder along with 20-25% w/w n-butyl acetate, 10-15% w/w xylene, 1-5% w/w ethyl benzene and 4-hydroxy-4-methyl-pentane-2-on.

### Example 4

### Material Testing

### Chemical Resistance

The tests were performed according to DIN 68861. Exposure duration was 16 hours. Acetic acid, instant coffee, black tea, citric acid 10% in water, sodium carbonate 10% in water, ammonia water 10% in water, spirit 48% in water, white wine/red wine/fortified wine, beer, cola beverages, black currant juice, condensed milk, water, benzene, acetone, ethyl/butyl acetate 1:1, butter, olive oil, stamp ink, cleaning agent (surfactant), 5% cooking salt in water, lipstick and disinfectant each yielded no visible changes (exposure group A).

Several tests to determine behavior relative to glass cleaning agents are additionally performed in conjunction with further wear tests. A cleaning treatment was simulated by modifying the test conditions (proceeding according to DIN 52 347, TABER abraser frictional wheel replaced by felt wheel). Added liquid glass cleaner like SIDOLIN® or AJAX® resulted in no changes to the coating.

### Outdoor Weathering Tests

Two respective samples (30×30 cm) were exposed to the elements over a prolonged period of time on outdoor weathering terrain. The glasses where aligned at an angle of 45°, one toward the south, the other toward the north. A visual inspection of the test specimens revealed no changes in color and translucence. Adhesion of the lacquer to the substrate was unchanged from before ageing. The test specimens hence exhibit a good weathering stability.

### Abrasion and Scratch Resistance Tests

The following tests were drawn upon for evaluation purposes to arrive at a practical and meaningful conclusion:

| | |
|---|---|
| DIN 52 347 | Wear Test (TABER abraser |
| | frictional wheel method) |
| DIN 53 799 | Testing of plates with decorative |
| | surface on amino resin basis |
| | (scratch hardness test) |
| DIN 53 778 | Evaluation of cleanability and washing |
| | and scrub resistance of |
| | paint films |
| TABER Test | 350 cycles CS10F/500 g |
| Scratch | 100 g (silk-screen printing samples Wesel 250 g) |
| hardness test | |
| Scrub resistance | 3500 cycles (exposure |
| | continued until traces of |
| | wear first detected) |

The results reveal that the coated glass panes can clearly sufficiently withstand exposure to mechanical scratching in the application in question.

### High-Humidity Climate Test

Four samples were tested in a 30 cm×30 cm format. The samples are in perfect condition 1800 hours into the test.

### UV Resistance

Eight samples (20 cm×30 cm) were irradiated with UV light. Four samples were irradiated on the lacquer side, and the remaining four samples were irradiated on the glass side. The samples are in perfect condition 1800 hours into the test. The lacquer has a good UV stability.

### Fire Behavior

A Pyran S® glass pane (Schott) (6.1 cm×9.1 cm) coated according to the invention was s fire behavior according to DIN 4102-13 to determine the fireproof duration teral exposure to fire. The test specimen was built into a test furnace, coating was on the side facing away from the fire.

| Test Duration (min) | Observations on Glass Pane |
|---|---|
| 7 | The coating turns black |
| 30 | No change |
| 80 | The coating turns clear |
| 90 | No change, end of exposure to flame |

Consequently, the coated test specimen also reaches a fireproof duration of 90 minutes.

### Surface Tension

Single-sheet safety glasses (11 cm×3.6 cm) from Glashaus Brich in Ingolstadt were coated according to the invention. Uncoated glasses will also be measured for comparison purposes.

The surface tension value was determined for 3 respective panes. A measuring device from Stain Optics, Model Laser Gasp, was used for measuring purposes. The surface tension was determined at three points on the pane. The results have been tabulated below.

| Pane, | | Tension | Pane, | | Tension |
|---|---|---|---|---|---|
| uncoated | Degrees | (N/mm²) | coated | Degress [°] | (N/mm²) |
| 01-P1 | 67,500 | 101,226 | 10-P1 | 70,000 | 115,200 |
| 01-P2 | 69,000 | 109,230 | 10-P2 | 68,500 | 106,444 |
| 01-P3 | 66,000 | 94,175 | 10-P3 | 68,000 | 103,779 |
| 02-P1 | 69,000 | 109,230 | 07-P1 | 69,500 | 112,146 |
| 02-P2 | 69,000 | 109,230 | 07-P2 | 69,000 | 109,230 |
| 02-P3 | 69,000 | 109,230 | 07-P3 | 68,000 | 103,779 |
| 03-P1 | 70,000 | 115,200 | 06-P1 | 69,500 | 112,146 |
| 03-P2 | 68,500 | 106,444 | 06-P2 | 70,500 | 118,405 |
| 03-P3 | 67,000 | 98,780 | 06-P3 | 68,000 | 103,779 |

1. A method for manufacturing a glass body with coated surface, characterized in that the method comprises the following steps:
Cleaning and/or coating at least a partial area of the glass surface with a primer/cleaner;
Applying an isocyanate-curing polyacrylate lacquer containing mineral particles in a layer thickness of at least 10 μm to at least a partial area of the glass surface, and
Curing the coating:

2. The method according to claim 1, characterized in that the method additionally comprises one or more of the following steps independently from each other:
Mechanically removing adhering residual coatings on the glass surface;
Partially covering the glass surface, in particular with a masking film;
Removing the masking film and/or
Abrading the partially or completely cured coating to break the pointed edges.

3. The method according to one of the preceding claims, characterized in that the primer includes or comprises a polar, organic solvent having 2 to 12 carbon atoms, preferably 2 to 4, and at least one of the following groups: alcohol, keto, aldehyde, ester or acid group(s), preferably a C2 to C3 alcohol, and preferably less than 5% w/w, preferably <1% w/w, of water independently thereof.

4. The method according to one of the preceding claims, characterized in that the residual coatings on the glass are removed by polishing with steel wool, in particular stainless steel wool.

5. The method according to one of the preceding claims, characterized in that the polyacrylate lacquer containing mineral particles is applied via silk-screen printing, spraying or rolling, preferably via silk-screen printing or spraying.

6. A glass body with coated surface, characterized in that the coating has an isocyanate-cured polyacrylate lacquer containing mineral particles.

7. The glass body with coated surface or method according to one of the preceding claims, characterized in that the cured coating has a layer thickness of 10 to 50 μm, preferably 15 to 30 μm.

8. The glass body with coated surface or method according to one of the preceding claims, characterized in that the mineral particles are oxides or mixed oxides of aluminum and/or silicon, including hydrates thereof.

9. The glass body with coated surface or method according to one of the preceding claims, characterized in that the mineral particles have an average diameter of 2 to 30 μm, preferably 5 to 25 μm.

10. The glass body with coated surface or method according to one of the preceding claims, characterized in that dyes, in particular color pigments, are added to the polyacrylate lacquer to manufacture color coatings.

11. The glass body with coated surface or method according to one of the preceding claims, characterized in that the glass body is acrylic glass, fire-resistant glass or multi-layer/composite glass, preferably type G-glazing fire-resistant glass and single-sheet safety glass (ESG), and that the coating is further preferably applied to the glass surface in built-in condition, in particular built into a frame.

12. The glass body with coated surface or method according to one of the preceding claims, characterized in that the glass body is single-sheet safety glass, and the coated glass has a surface tension that is roughly the same or maximally reduced by 10% relative to the uncoated glass.

13. The glass body with coated surface or method according to one of the preceding claims, characterized in that the polyacrylate lacquer is 2-component lacquer obtainable from at least one polyacrylate binder containing mineral particles and at least one isocyanate hardener having two or more reactive isocyanate groups per molecules, protected if necessary.

14. The glass body with coated surface or method according to one of the preceding claims, characterized in that the solvent share in the polyacrylate lacquer measures 20 to 80% w/w prior to application.

15. The glass body with coated surface or method according to one of the preceding claims, characterized in that the solvent contains hydrocarbons and esters or alkoxy ester with 4 to 12, in particular 6 to 10 carbon atoms.

16. The glass body with coated surface or method according to one of the preceding claims, characterized in that the hardener contains a C4 to C12 diisocyanate and, if necessary, a silane derivative.

17. A method according to one of claims 1 to 5, characterized in that the method additionally involves the step of removing all residue without damaging the glass surface using a halogen hydrocarbon-containing stripper.

18. A use of the glass body with coated surface according to one of claims 7 to 16 for sun or visual protection, as safety labeling on glass, or as part of a floodlight system, in particular in hospitals.
